(19) United States
(12) Patent Application Publication
(10) Pub. No.: US 2014/0240339 A1
(43) Pub. Date: Aug. 28, 2014

(54) PERSONAL VISUALIZATION OF HEALTH CONDITIONS

(71) Applicant: International Business Machines Corporation, Armonk, NY (US)

(72) Inventors: Mark Hsiao, Taipei (TW); Pei-Yun Sabrina Hsueh, New York, NY (US); Ci-Wei Lan, Taipei City (TW); Sreeram Ramakrishnan, Yorktown Heights, NY (US)

(73) Assignee: International Business Machines Corporation, Armonk, NY (US)

(21) Appl. No.: 14/178,922

(22) Filed: Feb. 12, 2014

(30) Foreign Application Priority Data
Feb. 27, 2013 (TW) 102107101

(51) Int. Cl. G06F 19/00; G06T 11/00; G06T 11/60

(52) U.S. Cl. CPC G06F 19/3481; G06T 11/60; G06T 11/001
USPC 345/589; 345/619

(57) ABSTRACT

A method and a system for personal visualization of health conditions. The method includes: obtaining a first digital image of a visible physical feature from a user having at least one health condition; extracting descriptive data for describing the visible physical feature from the first digital image, wherein the descriptive data have adjustable values by digital image processing; determining a health condition parameter of the user, and associating the health condition parameter with the descriptive data; determining a value of the health condition parameter; automatically adjusting the value of the descriptive data in the first digital image based on the determined value of the health condition parameter and the association of the health condition parameter with the descriptive data; and generating a second digital image from the first digital image according to the adjusted value of the descriptive data, and displaying the visible physical feature in the second digital image to reflect the adjusted value of the descriptive data.

### CROSS-REFERENCE TO RELATED APPLICATION

This application claims priority under 35 U.S.C. §119 from Taiwanese Patent Application 102107101, filed on Feb. 27, 2013, the entire contents of which are incorporated herein by reference.

### BACKGROUND OF THE INVENTION

1. Field of the Invention

The present invention relates to visualization of health conditions/results of treatment plans, and more particularly, to personal visualization of health conditions/results of treatment plans.

2. Description of the Related Art

Physicians usually explain diagnosis or treatment plans to patients orally, in writing, and/or by diagrams. However, patients often find it difficult to understand the medical jargons used by physicians, the diagnosis stated in a medical checkup report, and the physiological measurement data. In particular, patients are unable to envision possible changes in their health conditions. For instance, it is difficult for laymen to envisage how BMI (body mass index) values and the like will cause changes to their own health conditions or changes to their own appearance. As a result, in plenty situations, patients seldom receive really helpful information or warning based on conventional diagnosis reports or medical checkup reports. For the aforesaid reason, when asked to choose a treatment plan, patients typically are hard to have good understanding of the effect of the expected results of various treatment plans by themselves.

According to the prior art, the aforesaid medical information is communicated to patients by images or pictures of an avatar or virtual model to enhance patients' comprehension by means of the expected results of diagnosis reports or treatment plans and the adjustment of the avatar's appearance. For more details, see U.S. Pat. No. 5,867,171, U.S. Pat. No. 6,817,979, and US 2010/0251117.

### SUMMARY OF THE INVENTION

One aspect of the present invention provides a computer-implemented method for personal visualization of health conditions according to an embodiment of the present invention includes: obtaining a first digital image of a visible physical feature of a user; extracting descriptive data for describing the visible physical feature from the first digital image, wherein the descriptive data includes a plurality of values adjustable by digital image processing; determining a health condition parameter of the user, and identifying association of the health condition parameter with the descriptive data; determining a given value of the health condition parameter; adjusting automatically the plurality of values of the descriptive data pertaining to the visible physical feature in the first digital image according to the given value and the association of the health condition parameter with the descriptive data to create a plurality of adjustable; and generating a second digital image from the first digital image according to the adjusted values of the descriptive data and displaying the visible physical feature in the second digital image to reflect the adjusted values of the descriptive data.

A computer system, comprising a host computer, wherein the host computer includes: a bus system; a memory coupled to the bus system, wherein the memory includes a computer-executable instruction; and a processing unit connected to the bus system, wherein the processing unit executes the computer-executable instruction to implement a method. The method includes: obtaining a first digital image of a visible physical feature of a user; extracting descriptive data for describing the visible physical feature from the first digital image, wherein the descriptive data comprises a plurality of values which are adjustable by digital image processing; determining a health condition parameter of the user and identifying an association of the health condition parameter with the descriptive data; determining a given value of the health condition parameter; adjusting automatically the plurality of values of the descriptive data according to the given value and the association of the health condition parameter with the descriptive data to create a plurality of adjusted values; and generating a second digital image from the first digital image according to the plurality of adjusted values of the descriptive data and displaying the visible physical feature in the second digital image to reflect the plurality of adjusted values of the descriptive data.

A computer readable non-transitory article of manufacture tangibly embodying computer readable instruction which, when executed cause a computer to carry out the steps of a method. The method includes: obtaining a first digital image of a visible physical feature of a user; extracting descriptive data for describing the visible physical feature from the first digital image, wherein the descriptive data comprises a plurality of values which are adjustable by digital image processing; determining a health condition parameter of the user and identifying an association of the health condition parameter with the descriptive data; determining a given value of the health condition parameter; adjusting automatically the plurality of values of the descriptive data according to the given value and the association of the health condition parameter with the descriptive data to create a plurality of adjusted values; and generating a second digital image from the first digital image according to the plurality of adjusted values of the descriptive data and displaying the visible physical feature in the second digital image to reflect the plurality of adjusted values of the descriptive data.

Reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that can not be present in all embodiments of the invention.

The following description, the appended claims, and the embodiments of the present invention further illustrate the features and advantages of the present invention.

### BRIEF DESCRIPTION OF THE DRAWINGS

In order that the advantages of the present invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a schematic view of a computer system according to a specific embodiment of the present invention.

FIG. 2 is a schematic view of the process flow of a method according to a specific embodiment of the present invention.

FIG. 3A through FIG. 3C show digital images of visible physical features according to the specific embodiment of the present invention.

FIG. 4 is a schematic view of the process flow of a method according to another specific embodiment of the present invention.

FIG. 5 is a schematic view of the process flow of a method according to yet another specific embodiment of the present invention.

### DETAILED DESCRIPTION OF THE PREFERRED EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification can, but do not necessarily, all refer to the same embodiment.

As will be appreciated by one skilled in the art, the present invention can be embodied as a computer system/device, a method or a computer program product. Accordingly, the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, the present invention can take the form of a computer program product embodied in any tangible medium of expression having computer-usable program code embodied in the medium.

Any combination of one or more computer usable or computer readable medium(s) can be utilized. The computer-usable or computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium can even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium can be any medium that can contain, store, communicate, propagate, or transport the program for use by or in connection with the instruction execution system, apparatus, or device. The computer-usable medium can include a propagated data signal with the computer-usable program code embodied therewith, either in baseband or as part of a carrier wave. The computer usable program code can be transmitted using any appropriate medium, including but not limited to wireless, wireline, optical fiber cable, RF, etc.

Computer program code for carrying out operations of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer or server can be connected to the user's computer through any type of network, including a local area network (LAN) or a wide area network (WAN), or the connection can be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In one aspect, the present invention provides a computer system and method for personal visualization of health conditions to particularly improve on the performance of conventional visualization of health conditions.

As mentioned before, visualization of users' health conditions is achieved by an avatar or virtual model according to the prior art. However, benefits brought about by avatars or virtual models are limited, because the avatars or virtual models are not custom-made but come in a few predetermined templates with a limited number of options of appearance adjustment and a restrictive range of appearance adjustment, thereby failing to tell users' individual health conditions precisely. The aforesaid visualization of user health conditions by an avatar or virtual model does no more than presenting a diagnosis report or a medical checkup report by means of predetermined images, but fails to provide personalized presentation of users' individual health conditions.

By contrast, the present invention replaces conventional avatars and virtual models with users' own digital images, and involves adjusting users' own digital images to enable users to visualize changes in their health conditions, thereby achieving personal visualization of health conditions.

In another aspect, the present invention provides a computer system and method for personal visualization of results of treatment plans to particularly visualize expected results of a determined treatment plan by adjusting users' own digital images. The prior art discloses visualization of treatment plans by conventional avatars or virtual models, but the same, it fails to achieve personalized presentation of users' individual health conditions.

In yet another aspect, the present invention provides a computer system and method for personal visualization of selecting treatment plans by adjusting users' own digital images (instead of avatars or virtual models) to visualize the treatment results anticipated by the users, such that the users can select one or a combination of at least two of treatment plans.

The present invention provides, in another embodiment thereof, a computer program product stored in a computer-accessible medium. The computer program product comprises a computer-readable program executable on a computer system to implement the aforesaid methods.

In its another embodiment, the present invention provides a computer system comprising a memory and a processor. The memory stores therein a computer executable command. The processor accesses the memory to execute the computer executable command for performing the aforesaid method.

System Framework

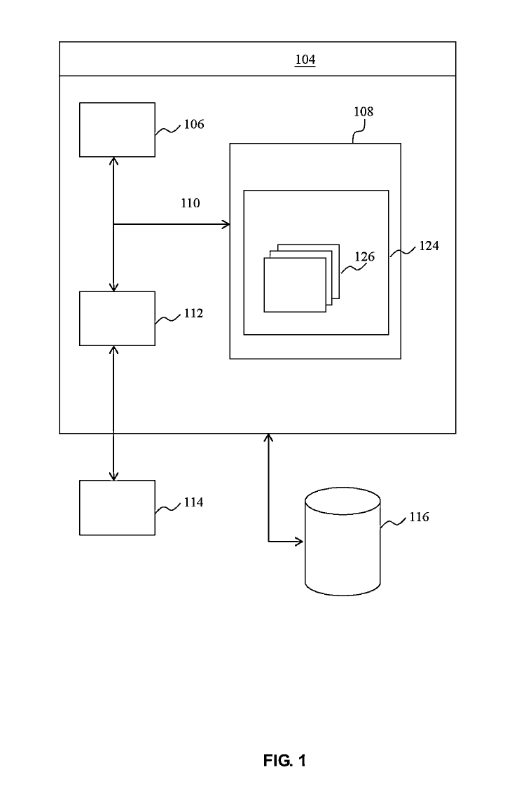

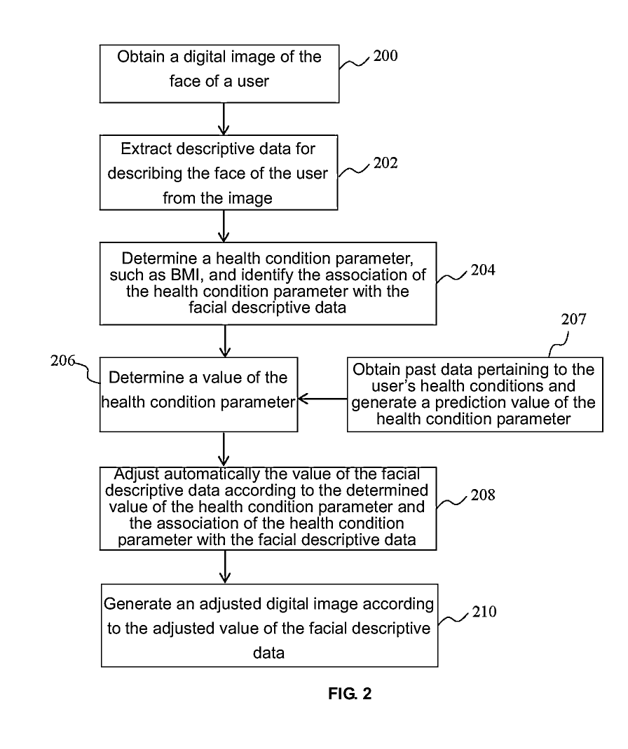

FIG. 1 illustrates the hardware framework of a computer system 104 according to an embodiment of the present invention. The computer system 104 comprises a processor 106, a memory device 108, a bus 110, and a device interface 112. The processor 106 accesses program code, such as a program 124, in the memory device 108 or an external storage device 116. The program 124 has one or more functional modules 126 for providing the functions (illustrated with FIG. 2 through FIG. 5 and described below) required by the present invention. The one or more functional modules 126 are a single instruction or multiple instructions distributed in multiple different program code segments, different programs, and multiple said memory devices 108.

The bus 110 functions as a communication link of various components in the computer system 104. The computer system 104 communicates with an external device 114 via the device interface 112. Furthermore, the computer system 104 communicates with the external device 114, the external storage device 116, or other computer devices/systems via a network. In this regard, the network can also come in the form of any type of connection, including a wide area network (WAN) or a local area network (LAN) of fixed connection, or dial-up Internet access service offered by an Internet service provider, and it is not restricted to wired or wireless connections. Furthermore, other hardware and software components (not shown, including additional computer systems, routers, and firewalls) can be included in the network.

In another embodiment, the basic framework and components of the computer system 104 can also come in the form of a typical personal computer or server, such as IBM's System X, Blade Center or eServer.

Although the present invention is hereunder illustrated with several simplified embodiments, persons skilled in the art understand that the present invention is not limited thereto.

### First Embodiment

FIG. 2 is a schematic view of the process flow of a method according to an illustrative embodiment of the present invention. The method illustrated by FIG. 2 is a computer-implemented method adapted for use in personal visualization of health conditions in conjunction with a system 104 shown in FIG. 1.

Step 200: obtain a digital image of the face of a user. For instance, referring to FIG. 1, an external device 114 is provided in the form of a digital camera to take images of a user's face and upload the images to the computer system 104 by a device interface 112 such that the images are stored in a memory device 108 or are further stored in an external storage device 116 by means of the computer system 104. The aforesaid details are well known among persons skilled in the art and thus are not described in detail herein for the sake of brevity. Furthermore, although this exemplary embodiment is exemplified by a user's face, digital images of other visible physical features are feasible to use as well.

Step 202: extract descriptive data for describing the face of the user from the image, wherein the descriptive data have values adjustable by digital image processing, such as pixel data or graphic vector data. In an embodiment, a face detection technique can be employed to determine from the images a face-displaying region and then detect a pixel color (for example, RGB value) of the region so that the pixel color can be used as the descriptive data.

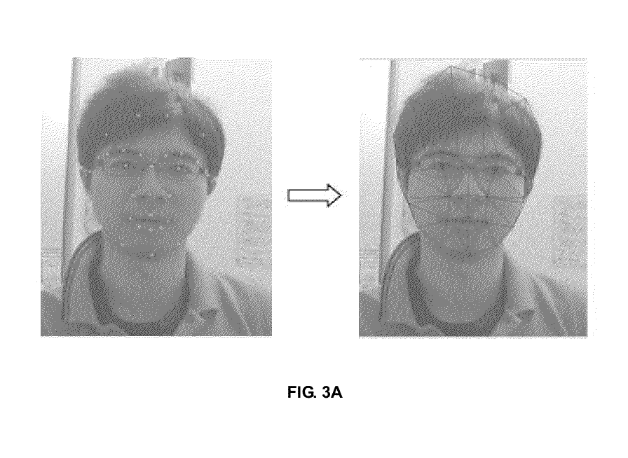

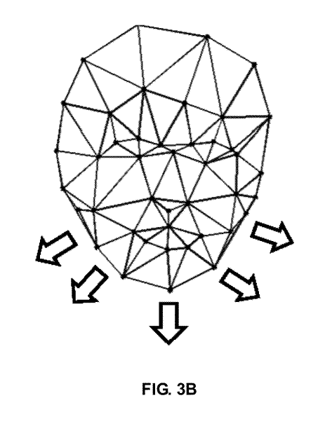

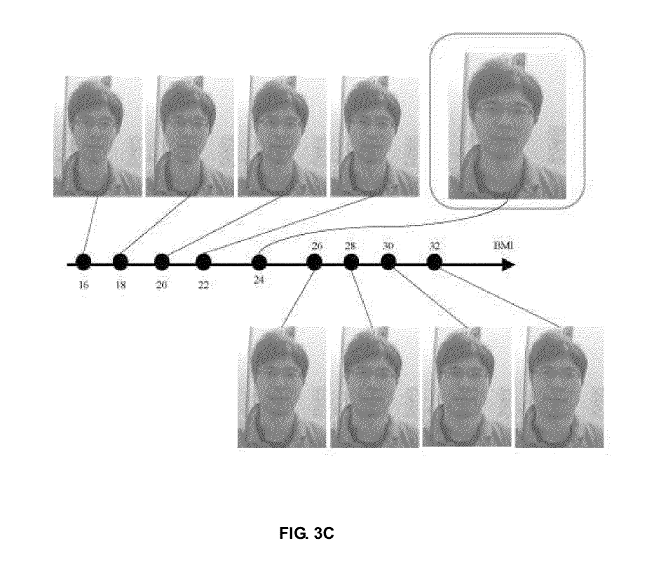

In another embodiment, a plurality of different feature points of the face is determined from the image, and a facial region is then determined by means of the feature points, as shown in FIG. 3A. Not only is the pixel color of the facial region serves as the descriptive data, but it is also feasible to selectively treat the pixel coordinate of the feature points displayed in the image as the descriptive data, such that it is not necessarily based on all the pixels in the whole facial region in the image as the descriptive data. Furthermore, it is also feasible to treat relative coordinates of the pixels of any two of the feature points displayed in the image as the descriptive data.

facial feature points are typically used for recognizing a user's facial image, and thus the quantity and positions of the facial feature points match each user's facial image and are unique thereto. Hence, in general, there are significant differences in the distribution of facial feature points between different users. For details of determination of facial feature points, see US 2008/0130961 or “Facial feature localization based on an improved active shape model”, Information Sciences, 178 (2008). The present invention is not restrictive of techniques of face detection and determination of facial feature points, as the techniques are well known among persons skilled in the art and thus are not described in detail herein for the sake of brevity.

Step 204: determine a health condition parameter which the user concerns, such as BMI (body mass index), and identify the association of the selected health condition parameter with the descriptive data. In addition to BMI, the present invention is applicable to any common health condition parameters used in medical checkup reports, such as, body weight or liver-function test index GOT or GPT. In this regard, even other “indirect” health condition parameters, such as daily sleep duration, daily fruit and vegetables intake, or weekly exercise hours. In an embodiment, a health condition parameter can have only two values, namely negative (denoted with 0) and positive (denoted with 1).

After the concerned health condition parameter has been determined, the association of the health condition parameter with the aforesaid facial descriptive data will be identified. Related details are described in a knowledge base. For instance, assuming that intake of fruit and vegetables is conducive to improvement of complexion, and then the association of daily intake of fruit and vegetables with the pixel color of the facial region can be identified. Furthermore, assuming that a change in the BMI value affects the facial outline, the association of a BMI value with the coordinates of one or multiple feature points on the facial outline can be identified. Alternatively, assuming that a change in a BMI value does not affect the coordinates of the feature points of eyes, nose, or corners of the mouth, the association of a BMI value with the relative coordinates between the feature points on the facial outline and the feature points of eyes, nose, or corners of the mouth is identified.

The relationship between a health condition parameter value and the value of the facial descriptive data can use a knowledge base as a reference and preset in the memory device 108 or the external storage device 116 so as to be accessed by functional modules 126 in a program 124. If no relationship is preset in the memory device 108 or the external storage device 116 but the memory device 108 or the external storage device 116 is provided with at least two different health condition parameters and values of facial descriptive data (for example, the user additionally provides her/his coordinate data of feature points on facial outline and BMI value kept on record a year ago), then the relationship between health condition parameter and changes in the values of the facial descriptive data can be inferred by the functional modules 126 in the program 124, using interpolation or extrapolation.

Step 206: determine a given value of the health condition parameter. In this step, the functional modules 126 directly use a given value entered by the user, for example, presetting BMI to 22. In another exemplary embodiment, the functional modules 126 need not wait for an input from user but can automatically preset BMI to all even numbers from 16 to 32 and then select one of the preset even numbers, so as to carry out the subsequent steps.

In another embodiment, as shown in step 207, the process flow of the method involves obtaining past data (for example, past medical records or health examination reports) pertaining to the user's health conditions and then generating a prediction of the user's health condition parameter (for example, BMI) to serve as the given value. Methods for predicting health parameters according to past data are disclosed in the prior art and thus the present invention is not restrictive of the prediction methods. Furthermore, the prediction preferably includes, but is not limited to, designing a function of a time parameter, such as a 6-month or 2-year prediction of the user's BMI value. Hence, in step 207, a prediction is based on the user's input or a prediction time parameter value (such as six months or two years) automatically specified by the functional modules 126.

Step 208: adjust automatically values of facial descriptive data (that is, adjusting the positions of feature points on the facial outline so as to move feature points) according to the health condition parameter value (for example, BMI value) determined in step 206 and the correlation between the health condition parameter determined in step 204 and changes in the values of facial descriptive data (for example, coordinate data or positions of features points on the facial outline in the image), as shown in FIG. 3B.

In a preferred embodiment, the process flow of the method further involves adjusting the coordinates of the feature points on the facial outline relative to the feature points of the eyes, nose, or corners of the mouth but keeping the coordinates of the feature points of the eyes, nose, or corners of the mouth unchanged, that is to say, moving the feature points on the facial outline relative to the feature points of the eyes, nose, or corners of the mouth. The adjustment of the feature points on the facial outline is disclosed in the prior art, for example, “Image warping using few anchor points and radial functions”, Computer Graphics Forum, 1995. Conventional methods for adjusting facial image outline, color, and tone are disclosed in U.S. Pat. No. 7,574,016 and US 2010/0135532. As methods for adjusting facial images are widely disclosed in the prior art, the present invention is not restrictive of the methods. However, according to the present invention, adjustment of a user's own image (as opposed to an avatar's image) must take into account its relationship with a health condition parameter.

Step 210: generate an adjusted digital image from the digital image obtained initially in step 200 according to the adjusted value of the facial descriptive data (for example, the adjusted positions of the feature points on the facial outline) and display the adjusted facial outline in the adjusted digital image to reflect the positions of the feature points on the adjusted facial outline. Hence, as described above, by simulating changes in the user facial appearance in an image, not only is personal visualization of the user's health conditions achieved, but the user can also specifically gain insight into his or her own health conditions.

Step 210 is followed by step 206 and step 207, and then the process flow of the method involves executing step 208 through step 210 again according to different given values of a health condition parameter or a prediction based on different time parameter values, so as to generate different adjusted digital images as shown in FIG. 3C (based on different BMI values).

### Second Embodiment

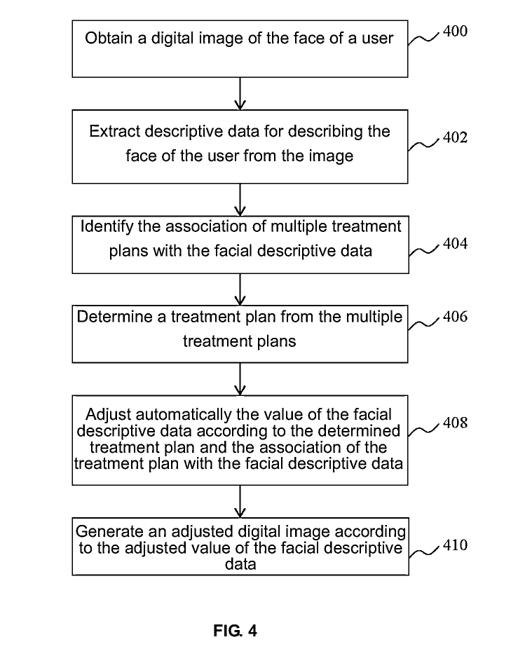

FIG. 4 is a schematic view of the process flow of a method according to an illustrative embodiment of the present invention. The method illustrated by FIG. 4 is a computer-implemented method adapted for use in personal visualization of results of treatment plans in conjunction with the system 104 shown in FIG. 1. According to the present invention, the treatment plans not only entail medical treatment, such as medication and surgery, but also involve home health care, such as lifestyle and diet control.

Step 400: obtain a digital image of the face of a user. For related details, see step 200.

Step 402: extract descriptive data for describing the face of the user from the image, wherein the descriptive data have values adjustable by digital image processing, such as pixel data or graphic vector data. For related details, see step 202.

Step 404: identify the association of multiple treatment plans with descriptive data for describing a user facial feature in an image. Step 404 is disclosed by the prior art, such as US 2010/0251117. For instance, the association of treatment plans of diet habits improvement with the pixel color of the facial region is identified (based on the assumption that intake of fruit and vegetables is conducive to improvement of complexion), or the association of treatment plans of laser facial whitening with the pixel color of the facial region is identified. The relationships between the treatment plans and changes in the values of facial descriptive data are described in a knowledge base and preset in the memory device 108 or the external storage device 116 to be accessed by the functional modules 126 in the program 124. In another embodiment, treatment plans are designed to be based on a function of a time parameter, and thus this step entails identifying the association of a time parameter in a treatment plan with the descriptive data for describing a user's face in an image.

Step 406: determine a treatment plan from the multiple treatment plans (for example, diet habits improvement and laser facial whitening) described in step 404. In this step, the functional modules 126 are directly provided in the form of treatment plans designated by the user, or one of the multiple treatment plans is selected according to some preset criteria for carrying out the subsequent steps. If the treatment plans are designed to be based on a function of a time parameter, this step is based on the user's input or time parameter values (for example, a week or a month) in the treatment plans specified automatically by the functional modules 126.

Step 408: adjust automatically the pixel color of the facial region (that is, changing the complexion shown in the image) according to the treatment plan (for example, laser facial whitening) determined in step 406, the specified time parameter value (if the treatment plan is designed to be based on a function of a time parameter), and the association, identified in step 404, between the treatment plan (and its time parameter) of laser facial whitening and changes in the value of the facial descriptive data (the pixel color of the facial region). According to the present invention, adjustment of the user's image (as opposed to an avatar's image) has to take into account of the relationship between treatment plans (or a time parameter value of a treatment plan).

Step 410: generate an adjusted digital image from the digital image obtained initially in step 400 according to the adjusted value of the facial descriptive data (for example, the pixel color of the facial region), display the adjusted facial complexion in the adjusted digital image to reflect the pixel color of the adjusted facial region, go back to step 406 to execute step 408 through step 410 again according to different treatment plans (or different time parameter values of the same treatment plan), so as to generate different adjusted digital images. By simulating changes in a user's facial appearance in an image, not only is personal visualization of treatment plans achieved, but a user is also allowed to further specifically gain insight into the expected results of the treatment plans.

### Variant Embodiment

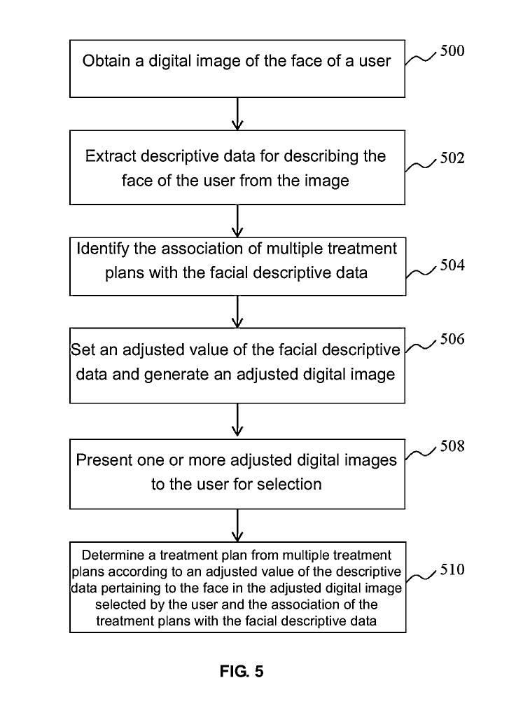

FIG. 5 is a schematic view based on variation of the embodiment illustrated with FIG. 4 and implemented by the computer-implemented method for personal visualization of selecting treatment plans with the system 104 illustrated with FIG. 1.

Step 500: obtain a facial digital image of a user. For related details, see step 400.

Step 502: extract descriptive data for describing the face of the user from the image, wherein the descriptive data have values adjustable by digital image processing, such as pixel data or graphic vector data. For related details, see step 402.

Step 504: identify the association of multiple treatment plans with the descriptive data (for example, the pixel color of the facial region) for describing the user's face in the image. For related details, see step 404. In another embodiment, each treatment plan is designed to be based on a function of a time parameter, this step involves identifying the association of the time parameter in each treatment plan with the descriptive data for describing the user's face in an image.

Step 506: set an adjusted value of the pixel color of the facial region according to a predetermined setting of the functional modules 126, generate an adjusted digital image from the digital image obtained initially in step 500 according to the pixel color of the adjusted facial region, and display the adjusted facial complexion in the adjusted digital image to reflect the pixel color of the adjusted facial region. This step can be repeatedly carried out according to different adjusting values so as to generate multiple adjusted digital images (and thereby display different facial complexions). For related details, see step 410. The difference between step 506 and step 410 is described as follows: in step 410, the adjusted value of the pixel color of the facial region depends on the determined treatment plan; in step 506, no treatment plan has yet been determined, and the adjusted value of the pixel color of the facial region can be directly set by the functional modules 126 in advance.

Step 508: present to the user the multiple adjusted digital images (adapted to reflecting the pixel colors of the adjusted facial region, respectively, and) generated in step 506 so as for the user to select one of the multiple adjusted digital images. That is to say, the user selects the intended facial complexion from multiple different facial complexions.

Step 510: determine a treatment plan from multiple treatment plans (for example, diet habits improvement and laser facial whitening) described in step 504 according to the facial region pixel color adjustment reflected in the adjusted digital image selected in step 508 by the user and the association of the multiple treatment plans of step 504 with the descriptive data (that is, the pixel color of the facial region) for describing the user facial feature in the image, so as to obtain a treatment plan which suits the user's intended complexion. In the embodiment where a treatment plan is designed to be based on a function of a time parameter, step 508 not only involves determining a treatment plan, but also involves determining the value of the time parameter of the treatment plan, for example, laser facial whitening (1 week) or diet habits improvement (8 weeks). In another embodiment, step 508 involves using linear planning or any other means of mathematical planning to determine a combination of at least two treatment plans and an appropriate value of the time parameter of each of the treatment plans in combination, for example, laser facial whitening (1 week) performed together with diet habits improvement (8 weeks), or laser facial whitening (2 weeks) performed together with diet habits improvement (4 weeks).

The present invention can be embodied in any other specific manners without departing from the spirit or essential features of the present invention. Every aspect of the aforesaid embodiments of the present invention must be deemed illustrative rather than restrictive of the present invention. Hence, the scope of the present invention is defined by the appended claims instead of the above description. All equivalent meanings and scope which fall within the appended claims must be deemed falling within the scope of the appended claims.

What is claimed is:

1. A computer-implemented method for personal visualization of health conditions, the method comprising:
(a) obtaining a first digital image of a visible physical feature of a user;
(b) extracting descriptive data for describing the visible physical feature from the first digital image, wherein the descriptive data comprises a plurality of values which are adjustable by digital image processing;
(c) determining a health condition parameter of the user, and identifying an association of the health condition parameter with the descriptive data;
(d) determining a given value of the health condition parameter;
(e) adjusting automatically the plurality of values of the descriptive data according to the given value and the association of the health condition parameter with the descriptive data to create a plurality of adjusted values; and
(f) generating a second digital image from the first digital image according to the adjusted values of the descriptive data and displaying the visible physical feature in the second digital image to reflect the plurality of adjusted values of the descriptive data.

2. The method for claim 1, wherein:
the visible physical feature in the first digital image includes a computer-distinguishable portion; and
the descriptive data includes color data pertaining to at least a pixel for displaying the portion.

3. The method for claim 1, wherein:
the visible physical feature in the first digital image includes a computer-distinguishable portion; and
the descriptive data includes coordinate data pertaining to at least a pixel for displaying the portion.

4. The method for claim 1, wherein:
the visible physical feature in the first digital image includes a first portion and a second portion which are computer-distinguishable; and
the descriptive data includes coordinate data pertaining to at least a first pixel for displaying the first portion relative to at least a second pixel for displaying the second portion.

5. The method for claim 1, further comprising:
executing step (d) through step (f) repeatedly with a plurality of different given values to obtain a plurality of second digital images based on the plurality of different given values.

6. The method for claim 1, wherein determining a given value of the health condition parameter further comprises:
generating a prediction of the health condition parameter of the user to serve as the given value according to past data pertaining to a plurality of health conditions of the user.

7. The method for claim 6, wherein determining a given value of the health condition parameter further comprises:
determining a time parameter value in the prediction of the health parameter of the user, wherein the prediction is designed to be a function of the time parameter.

8. The method for claim 7, further comprising:
executing step (d) through step (f) repeatedly with a plurality of different time parameter values to obtain a plurality of second digital images based on the plurality of different time parameter values.

9. A computer system, comprising a host computer, wherein the host computer comprises:
a bus system;
a memory coupled to the bus system, wherein the memory comprises a computer-executable instruction; and
a processing unit connected to the bus system, wherein the processing unit executes the computer-executable instruction to implement a method:
(a) obtaining a first digital image of a visible physical feature of a user;
(b) extracting descriptive data for describing the visible physical feature from the first digital image, wherein the descriptive data comprises a plurality of values which are adjustable by digital image processing;
(c) determining a health condition parameter of the user and identifying an association of the health condition parameter with the descriptive data;
(d) determining a given value of the health condition parameter;
(e) adjusting automatically the plurality of values of the descriptive data according to the given value and the association of the health condition parameter with the descriptive data to create a plurality of adjusted values; and
(f) generating a second digital image from the first digital image according to the plurality of adjusted values of the descriptive data and displaying the visible physical feature in the second digital image to reflect the plurality of adjusted values of the descriptive data.

10. A computer readable non-transitory article of manufacture tangibly embodying computer readable instruction which, when executed cause a computer to carry out the steps of a method:
(a) obtaining a first digital image of a visible physical feature of a user;
(b) extracting descriptive data for describing the visible physical feature from the first digital image, wherein the descriptive data comprises a plurality of values which are adjustable by digital image processing;
(c) determining a health condition parameter of the user and identifying an association of the health condition parameter with the descriptive data;
(d) determining a given value of the health condition parameter;
(e) adjusting automatically the plurality of values of the descriptive data according to the given value and the association of the health condition parameter with the descriptive data to create a plurality of adjusted values; and
(f) generating a second digital image from the first digital image according to the plurality of adjusted values of the descriptive data and displaying the visible physical feature in the second digital image to reflect the plurality of adjusted values of the descriptive data.
